(19) United States
(12) Patent Application Publication
(10) Pub. No.: US 2006/0080697 A1
(43) Pub. Date: Apr. 13, 2006

(54) Information processing appliance

(76) Inventor: Yukio Sugimura, Yokohama-shi (JP)

Correspondence Address: NATH & ASSOCIATES, 112 South West Street, Alexandria, VA, 22314, US

(21) Appl. No.: 11/221,707

(22) Filed: Sep. 9, 2005

(30) Foreign Application Priority Data
Sep. 10, 2004 (JP) P2004-264111

(51) Int. Cl. G11B 23/03

(52) U.S. Cl. 720/734

(57) ABSTRACT

A preferred embodiment of the present invention provides an information processing appliance comprising a first casing, a second casing, a slot portion housing detachably a cartridge carrying a disc-like recording medium, the slot portion being housed inside the first casing, a camera unit portion outputting image data of a captured image. In this information processing appliance, the second casing is mounted on the first casing so that one face of the first casing closely opposes one face of the second casing, and wherein the slot portion is provided on and along the one face of the first casing.

### BACKGROUND OF THE INVENTION

1. Field of the Invention

The present invention relates to an information processing appliance, specifically to such an information processing appliance that utilizes a removable cartridge carrying a disc-like recording medium that is rotated when writing data on or reading data therefrom.

2. Description of the Related Art

As a removable recording medium for use in an information processing appliance such as but not limited to a digital camera, a video camera, a note type personal computer, a portable music player, a personal digital assistance or the like, a drive apparatus that writes data on or reads data from a rotating disc-like recording medium, for example, a hard disc drive (HDD) apparatus utilizing a small hard disc having a diameter of as small as one inch built-in, in addition to a conventional memory card such as a CompactFlash (registered trademark) card, has now come to be in general use. An example includes a Microdrive (registered trademark) having the compatibility to a CompactFlash (CF) card.

Since a large capacity disc-like recording medium is built in, such a cartridge is suitable for the information processing appliance used to record or play a moving image requiring a large amount of data. As an example of such an information processing appliance is cited a digital camera disclosed in Japanese Patent Application Publication No. 2002-369121.

By the way, while the cartridge mentioned above has a fully downsized, flat shape in accordance with the shape of the built-in disc, it is a well known fact that such a cartridge has to be handled with care to keep the cartridge away from an impact shock or vibration applied thereon during its operation (Refer to Japanese Patent Application Publications No. 2002-369121 and No. 2003-297068 (for example theparagraph 0004 and so on)).

Specifically the shock exerted thereon in a direction of a disc plane, that is, in a direction perpendicular to the disc plane, may destroy the built-in disc drive apparatus. Regarding an information processing appliance that uses such a cartridge mounted, it has to be taken into consideration that a predetermined level or higher of impact (acceleration) is prevented from being applied to the cartridge in the direction.

In concrete terms, a permissible level of the shock is estimated as 2000 G or lower at the time of idle and as 200 G or lower at the time of operation. Therefore, an information processing appliance of such a type requires anti-shock performance satisfying such estimation.

By the way, since the cartridge is fully downsized, the information processing appliance utilizing such a cartridge can also be downsized and thereby the appliance can be handled quite easily. This may be somewhat disadvantageous from a different viewpoint. It is because such an easy-to-handle appliance can be handled carelessly so that the appliance may accidentally drop on a floor or hit a wall and thereby the appliance and its cartridge may experience a strong impact shock.

Therefore, unless a necessary measure is taken to prevent such a strong shock from exerting thereon, the disc drive apparatus housed in the cartridge may be broken, thereby deteriorating reliabilities of an information processing appliance.

Under these circumstances, the objective of the present invention lies in a provision of an information processing appliance that is capable of preventing a cartridge mounted therein from experiencing an excessive impact shock and thus has a high reliability.

### SUMMARY OF THE INVENTION

In order to achieve the above objective, a first aspect of the present invention provides an information processing appliance comprising a casing, a wall portion formed integrally with the casing so as to arise inward from the casing, and a slot portion housed inside the casing and supported by the wall portion, the slot portion housing removably a cartridge carrying a disc-like recording medium.

A second aspect of the present invention provides an information processing appliance comprising a first casing, a second casing, a slot portion housed inside the first casing, the slot portion housing removably a cartridge carrying a disc-like recording medium, and a camera unit portion outputting image data of a captured image. In this information processing appliance, the second casing is mounted on the first casing so that one face of the first casing closely opposes one face of the second casing, and wherein the slot portion is provided on and along the one face of the first casing.

Preferably, in the information processing appliance according to the second aspect, the second casing is pivotably configured in relation to the first casing.

According to the present invention, even when a strong shock is applied to the information processing appliance from outside, the shock exerted on the mounted cartridge having the disc drive built in is reduced sufficiently enough to avoid breakage of the cartridge, thereby assuring high reliability.

### BRIEF DESCRIPTION OF THE DRAWINGS

In the accompanying drawings:

FIG. 1 is a perspective view illustrating an appearance of an information processing appliance according to a first embodiment of the present invention.

FIG. 2 is a perspective cross section explanatorily illustrating the information processing appliance according to the first embodiment of the present invention.

FIGS. 3A and 3B are a cross section explanatorily illustrating the information processing appliance according to the first embodiment of the present invention.

FIG. 4 is a perspective view illustrating an appearance of the information processing appliance according to a second embodiment of the present invention.

FIG. 5 is another perspective view illustrating an appearance of the information processing appliance according to the second embodiment of the present invention.

FIG. 6 is an explanatory drawing of an inner configuration of the information processing appliance according to the second embodiment of the present invention.

FIG. 7 is a perspective view illustrating an example of a cartridge mounted in an information processing appliance according to the present invention.

FIG. 8 is a perspective view illustrating a medium housing section of the information processing appliance according to the second embodiment of the present invention.

FIG. 9 is another perspective view illustrating a medium housing section of the information processing appliance according to the second embodiment of the present invention.

FIG. 10 is an exploded perspective view of the medium housing section of the information processing appliance according to the second embodiment of the present invention.

FIG. 11 is a perspective view illustrating a slot section of the information processing appliance according to the second embodiment of the present invention.

FIG. 12 is another perspective view illustrating the slot section of the information processing appliance according to the second embodiment of the present invention.

FIG. 13 is a plane view explanatorily illustrating a slot lock mechanism of the information processing appliance according to the second embodiment of the present invention.

FIG. 14 is a plane view explanatorily illustrating an essential part of the slot lock mechanism of the information processing appliance according to the second embodiment of the present invention.

FIGS. 15A and 15B are a partial perspective view explanatorily illustrating a first supporting state and a second supporting state in the information processing appliance according to the second embodiment of the present invention.

FIG. 16 is a perspective view explanatorily illustrating a switching mechanism of the information processing appliance according to the second embodiment of the present invention.

FIG. 17 is an explanatory view illustrating a modification of an information processing appliance according to the present invention.

FIG. 18 is a first view explanatorily illustrating another modification of an information processing appliance according to the present invention.

FIG. 19 is a second view explanatorily illustrating yet another modification of an information processing appliance according to the present invention.

FIG. 20 is a third view explanatorily illustrating still yet another modification of an information processing appliance according to the present invention.

FIG. 21 a schematic cross section explanatorily illustrating a configuration of the information processing appliance according to the second embodiment of the present invention.

FIG. 22 is a schematic cross section explanatorily illustrating a modification of the information processing appliance according to the second embodiment of the present invention.

### DESCRIPTION OF THE PREFERRED EMBODIMENTS

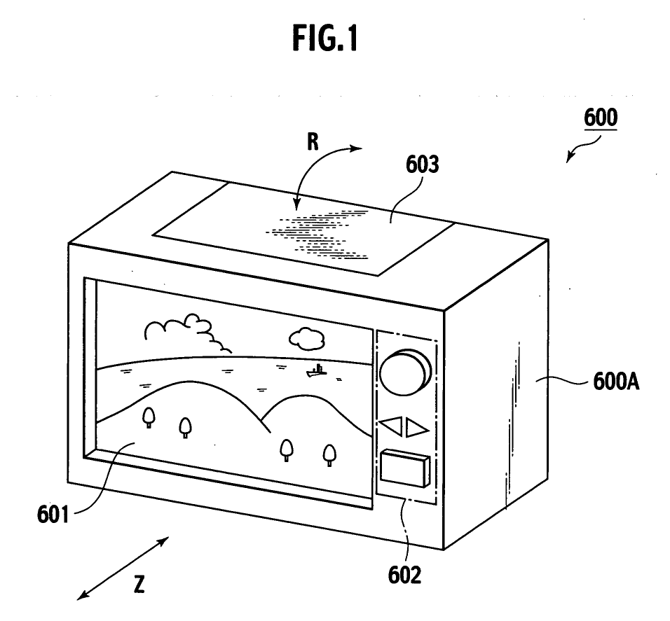

Referring to FIGS. 1 to 22, preferred embodiments according to the present invention will be described hereinafter.

### A First Embodiment

An information processing appliance according to a first embodiment is a portable image display apparatus. This apparatus will be described in detail referring to FIGS. 1 to 3.

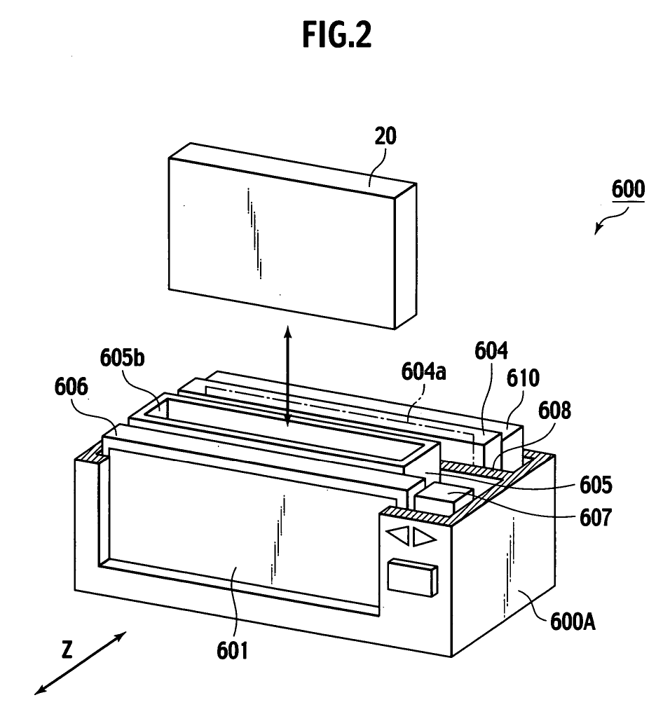

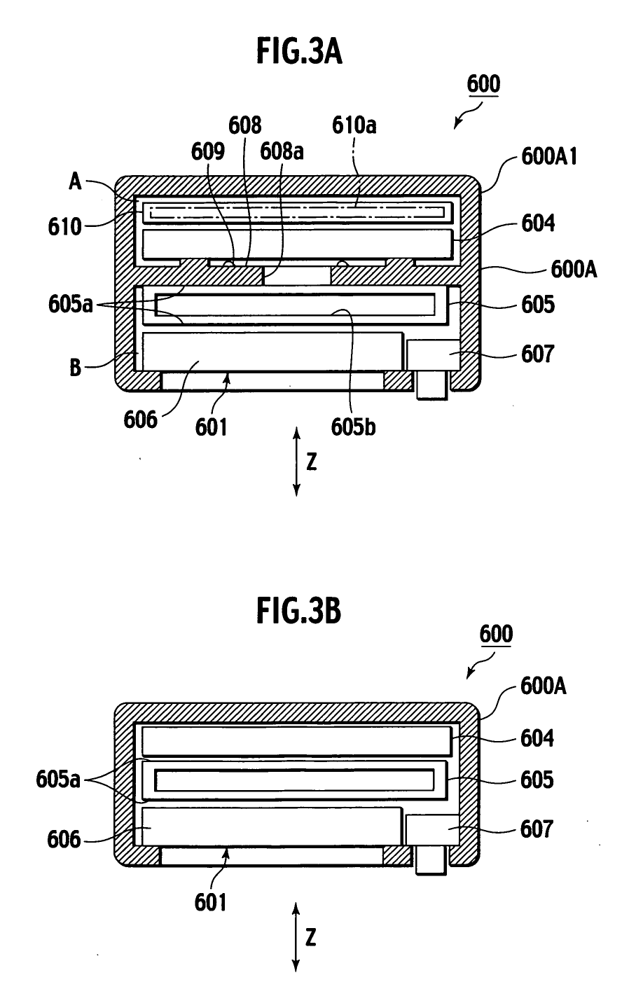

FIG. 1 is a perspective view illustrating an exterior. FIG. 2 is a perspective view including a partial cross section of a casing in order to schematically illustrate an inner structure. FIG. 3 is a transverse cross section view thereof.

A portable image display apparatus 600 is composed of a slot section 605 that allows a cartridge 20 carrying a recording medium to be inserted and removed. The portable image display apparatus 600 reads data recorded in the cartridge 20 and processes the data into an image to display the image on a display unit 606.

Namely, the portable image display apparatus 600 is comprised of a battery housing unit 610 housing a battery 610a as a power source, the display unit 606 including a display device 601, an operation unit 607 having a group of operation buttons 602, a slot unit 605 having an insertion mouth 605b through which the cartridge 20 is inserted or removed, and a control unit 604 controlling each unit above and an input/output interface unit (not shown), as a block. In addition, the portable image display apparatus 600 is comprised of a casing 600A housing the block. Moreover, the portable image display apparatus 600 may further include a communication interface, as a unit, for carrying out a radio-communication with external devices.

The display unit 606 is configured into a flat block and includes a display element such as but not limited to a liquid crystal display device and an organic electro luminescent (EL) or the like. The control unit 604 is configured into a flat block and includes a substrate 604a having a central processing unit (CPU) (not shown) and a control circuit or the like.

The casing 600A is provided with an openable and closable slot cover 603on the top face thereof. Opening the slot cover 603 makes the insertion mouth 605b visible, thereby enabling the cartridge 20 to be inserted or removed.

Each unit is electrically connected to one another using a signal wiring (not shown). The cartridge 20 houses the disc-like information recording medium and has a drive apparatus built in. The drive apparatus rotates the recording medium and thus reads data recorded thereon.

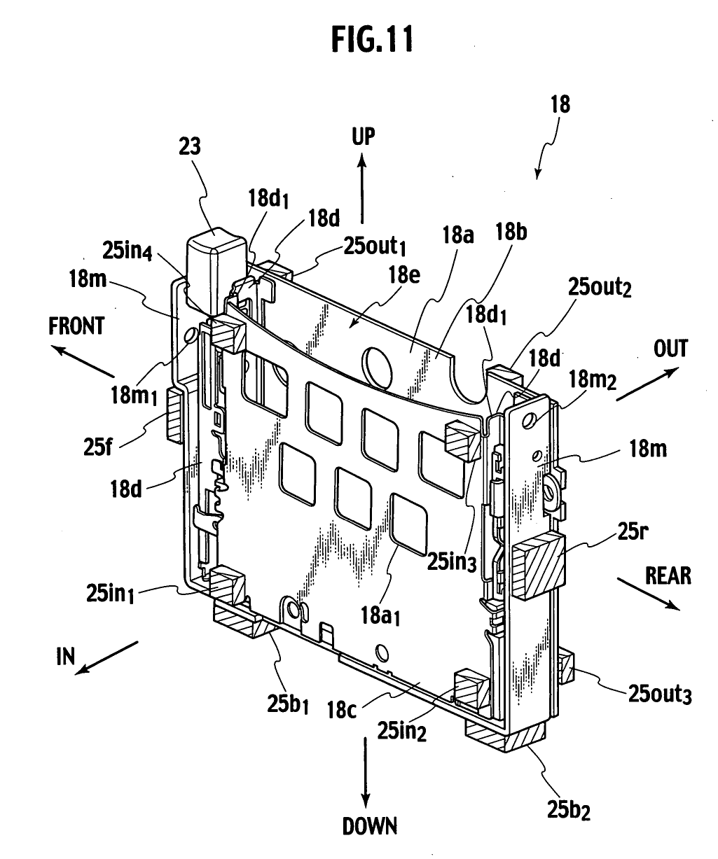

An example of the cartridge 20 includes a micro drive that has a flat, oblong shape, reflecting a shape of the disc-like recording medium housed therein. The details of the micro drive will be described later with reference to FIG. 11.

The casing 600A is formed for example by injection-molding thermoplastic resin such as but not limited to poly-carbonate (PC) or the like so as to have a unit supporting partition 608 as a part thereof so that the partition 608 arises inward to substantially divide the inside of the casing 600A into two sections which are referred to as an A section and a B section hereinafter.

The unit supporting partition 608 is not necessarily a flat wall but may be rib-shaped as extending from an outer shell 600A1 of the casing 600A toward inside.

In this embodiment, the unit supporting partition 608 has an opening 608a partially so as to allow a signal wiring (not shown) for electrically connecting the A section and the B section to pass therethrough.

In the A section is disposed the control unit 604 and in the B section is disposed the slot unit 605, the display unit 606 and the operation unit 607. Each of these is fastened with a fastening means (not shown) so as to substantially unite with the casing 600A.

In this configuration, the slot unit 605 is screwed only to the unit supporting partition 608 using a screw 609.

As mentioned above, since the cartridge 20 is shaped like a flat oblong, the slot unit 605 for housing the cartridge 20 is correspondingly shaped like a flat oblong. The slot unit 605 is fastened on the unit supporting partition 608 so that a flat face 605a of the slot unit 605 meets the partition 608.

Since the unit supporting partition 608 is a wall portion or a rib provided, not on the outer shell, but inside of the casing 600A, even when the portable image display appliance 500 hits an object, no shock is delivered directly to the unit supporting partition 608.

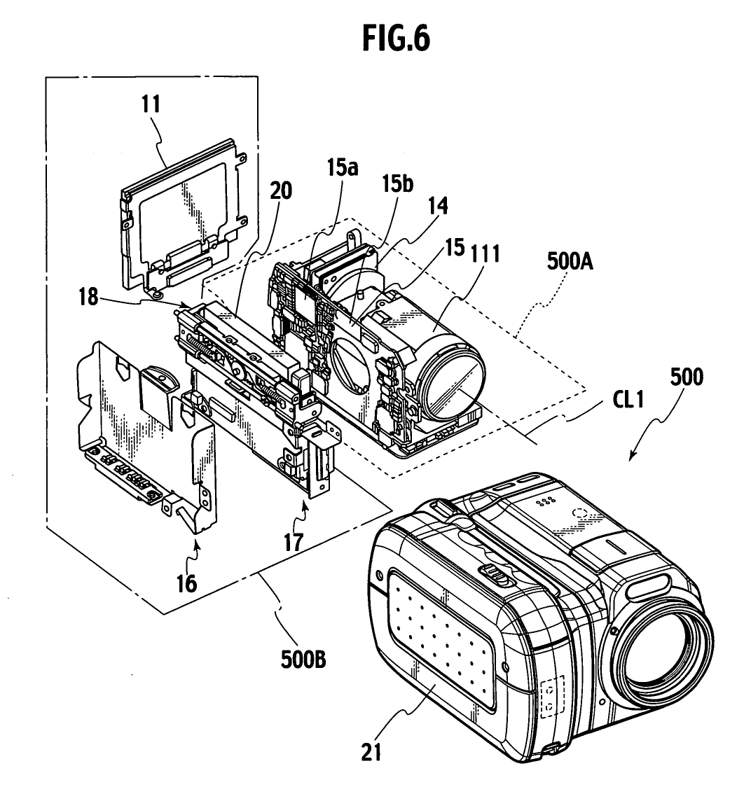

Moreover, since the casing 600A is formed of resin as mentioned above, the unit supporting partition 608 is flexible in a direction shown by an arrow Z in FIG. 6.

The direction Z is substantially perpendicular to a disc plane of the disc housed in the cartridge 20.

Therefore, even when shock is exerted on the portable image display appliance in the Z direction, the unit supporting partition 608 fastening the slot unit 605 thereon is capable of bending due to its flexibility, thereby absorbing the shock.

In other words, the unit supporting partition 608 serves as a dumper absorbing the shock exerted in the Z direction.

By this configuration, the shock exerted in the Z direction on the slot unit 605 supported by the unit supporting partition 608 is reduced extremely. Therefore, the disc drive apparatus housed in the cartridge 20 mounted in the slot unit 605 cannot be destroyed.

On the other hand, there is disposed the display unit 606 not on the outer shell but on the inner wall of the casing 600A so as to have the slot unit 605 positioned between the display unit 606 and the unit supporting partition 608.

Namely, the two flat faces 605a, 605a of the slot unit 605 do not directly face the outer shell 600A1.

In other words, the slot unit 605 is disposed between flat members (blocks) which are not the outer shell 600A1, facing its flat faces 605a toward the flat members. In addition, the slot unit 605 is supported by being connected to one of the members sandwiching the unit 605, without being supported directly by the outer shell 600A1.

FIG. 3B illustrates an example of the slot unit 605 by cross section. The slot unit 605 is disposed in the casing 600A so as to be interposed between the control unit 604 and the display unit 606, facing the flat faces 605a thereof respectively toward the units.

By this configuration, even when the portable image display appliance 600 hits an object or the like, no shock is directly delivered to the slot unit 605. Therefore, the cartridge 20 mounted in the slot unit 600 is free from an adverse effect and the drive apparatus therein cannot be destroyed.

Since the blocks sandwiching the slot unit 605 has a flat shape, the blocks can be disposed parallel with the slot unit 605, thereby realizing a layout efficiently utilizing the space inside of the appliance.

According to the configuration, the slot unit 605 and the blocks sandwiching the same oppose with other on their flat planes. Therefore, force exerted thereon is not concentrated but evenly deconcentrated, thereby dumping the shock from outside more preferably.

### A Second Embodiment

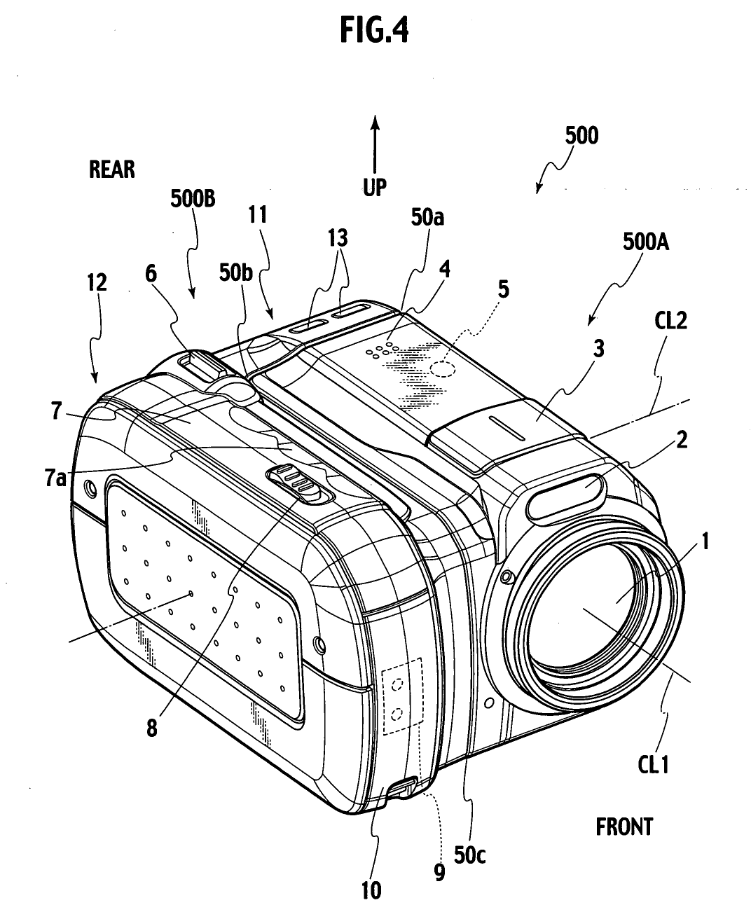

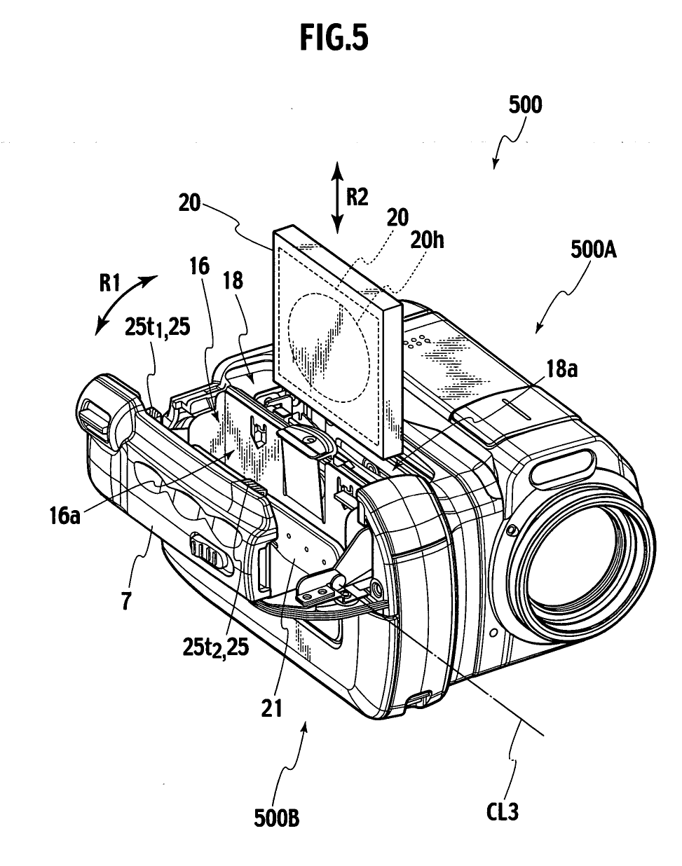

Next, a second embodiment will be described in detail with reference to FIGS. 4 to 22.

An information processing appliance according to the second embodiment is a video camera, the appearance of which is illustrated in FIG. 4.

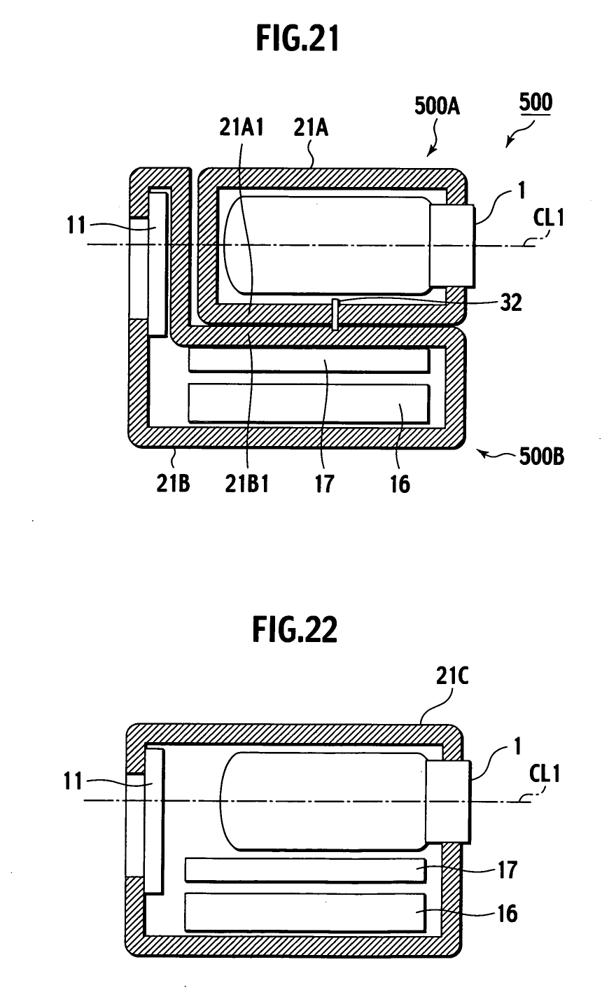

The video camera according to the second embodiment is configured, though described in detail later, by rotatably joining a camera unit 500A having a lens section 111 and a body 500B including a liquid display section 11, a battery housing section 16, and a media housing section 17 with a shaft supporting portion 32 (FIG. 21). A portion of an outer shell wall in which each casing (the exterior cover 21A, 21B) opposing with each other along an optical axis CL1 corresponds to the unit supporting partition 608 in the first embodiment. The lens section 111, the liquid display unit 11, the battery housing section 16, and the medium housing section 17 are each disposed as a block constituting the video camera. Instead of the liquid crystal section 11 using liquid crystal elements, a display section using other display elements such as but not limited to an organic EL or the like may be used.

The medium housing section 17 that corresponds to the slot unit 605 of the first embodiment is disposed between the battery housing section 16 and outer walls 21A1, 21B1 of the casing 21A1, 21B1, the outer walls opposing each other. Due to this configuration, the medium housing section 17 is prevented from directly opposing the outer shell of the exterior of the casing 21A, 21B (see FIG. 21).

Therefore, a technological idea shown in the first embodiment is applied also to this embodiment.

In addition, when the video camera as an information processing appliance is configured as a single component and covered with a casing 21C (see FIG. 22), the medium housing section 17 can be disposed between the lens section 111 and the battery housing section 16.

Therefore, even in this case, the technological idea is applied.

A configuration of such a video camera of the second embodiment will be described in detail hereinafter.

This video camera (termed as just an appliance 500 as the case may be) is composed of a lens unit 500A and a body unit 500B that is L-shaped.

These units can be separated at a separation line connecting points 50a, 50b, 50c in FIG. 4. The lens unit 500A is pivotable around a pivot axis CL2 with respect to the body unit 500B within a predetermined range of angle by use of a pivoting mechanism (not shown).

The lens unit 500A is comprised of a zoom lens 1 having an optical axis CL1, an electric flush 2, a stereo microphone 3, a speaker 4, a first group of operation buttons 5, and a first slot (not shown) provided on a bottom face. On the first slot is mounted a memory card.

The body unit 500B is comprised of a zoom lever 6, a hinge flip cover 7, a lock lever 8, a group of connecting terminals 9, a terminal cover 10 covering the group of the connecting terminals 9, a second group of operation buttons 12, and a third group of operation buttons 13. In the hinge flip cover 7 is provided a recess portion 7a to be gripped by user's fingers when he or she grips the video camera 500. When taking a shot, the video camera is held so that the hinge flip cover 7 is enfolded by user's hand.

Next, an inner configuration of the video camera 500 will be described with reference to FIG. 6. FIG. 6 is a perspective view of the video camera, including each block constituting the video camera for the sake of easy understanding, the perspective view corresponding to FIG. 4.

In FIG. 6, the lens unit 500A has a zoom lens 1, an image pickup device 14 for converting an image into an electric signal, the device 14 being disposed behind the zoom lens 1, a substrate 15 on which an image signal processing circuit 15b is disposed, the substrate 15 being disposed on the bottom and left portion of the lens unit 500A, a first slot (not shown) disposed beneath the bottom face of the image pickup device 14. On the substrate 15, there is mounted a CPU 15a control an entire operation of the video camera 500.

On the other hand, the body unit 500B has a liquid display unit 11 disposed on the rear portion of the body unit 500B, and a battery housing unit 16 and a medium housing unit 17, each of which is disposed parallel with the optical axis CL1. The body unit 500B is configured to have the exterior cover 21 covering the units 11, 16, 17.

The medium housing unit 17 is comprised of a second slot 18 (described later). FIG. 6 illustrates where a cartridge 20 (described later) is mounted in the second slot 18. In addition, the medium housing unit 17 is supported by a portion of the exterior cover 21, the portion being on the body unit 500B side, and is composed so as not to be directly connected to the outer portion of the exterior cover 21.

The battery housing unit 16 is disposed between the medium housing unit 17 and an outer shell of the exterior cover 21. Because of this, shock exerted on the outer shell of the exterior cover 21 is prevented from being directly delivered to the medium housing unit 17.

A disposing of the battery housing unit 16 mounting therein a relatively heavy battery near the outer shell allows the weight center to fall in more of the center of user's hand when the video camera 500 having the battery mounted is held. Therefore, the video camera is stably held and comfortably used for a long-time shooting.

Referring to FIG. 4 again, the hinge flip cover 7 can be opened by moving a lock lever 8 to remove a lock of a locking mechanism (not shown in FIG. 4) so that an opening 18a of the second slot 18 provided for inserting or removing the cartridge 20 and the battery (not shown) are seen from above of the camera 500.

Namely, the video camera 500 is configured in such a way that opening of the hinge flip cover 7 allows the battery and the cartridge 20 to be inserted and removed from above.

FIG. 5 illustrates a case in which the hinge flip cover 7 is opened in contrast with FIG. 4.

The hinge flip cover 7 is engaged with a shaft (not shown) provided along a pivot axis CL3 of the exterior cover 21 and pivotable around the pivot axis CL3 (R1).

In this situation, the cartridge 20 is inserted or removed in an up/down direction (an arrow R2 in FIG. 4) with respect to the opening 18a.

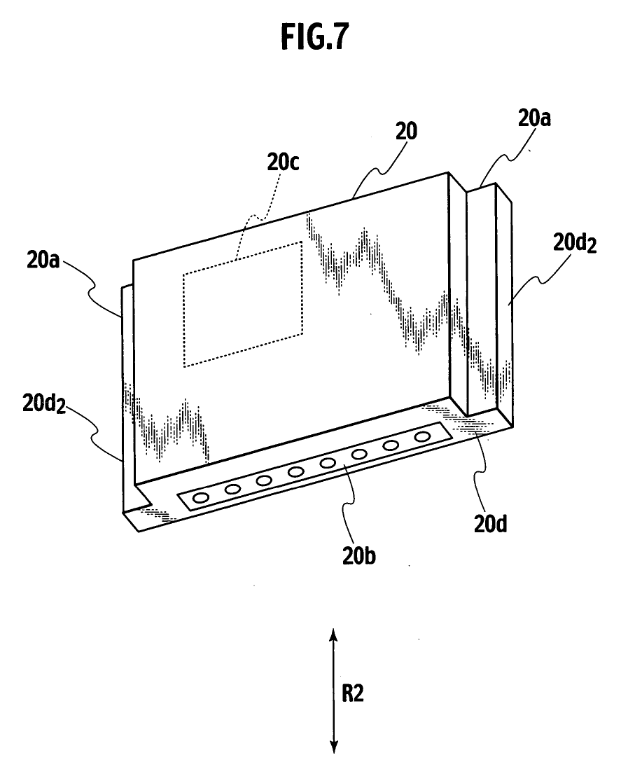

The cartridge 20 will be described with reference to FIG. 7 that is a perspective view thereof.

The cartridge 20 is flat- and oblong-shaped and has a hard disc drive (HDD) 20c built in, the HDD 20c using a hard disc as a recording medium 20h therein.

There is provided a female connector portion 20b on one side 20d of the cartridge 20, the connector portion 20b serving a signal exchange between the HDD 20c and a given circuit outside the cartridge 20.

The female connector portion 20b is inserted and removed in an R2 direction of FIG. 7, with respect to a male connector portion (described later) of the appliance 500.

On sides 20d2 opposing each other, except for the one side 20d, there is formed a step 20a extending an insertion/removal direction (R2 direction).

The step 20a is engaged with a guide portion (described later) provided on the second slot 18 of the appliance 500 to serve as a guide, thereby enabling a smooth insertion/removal of the cartridge 20.

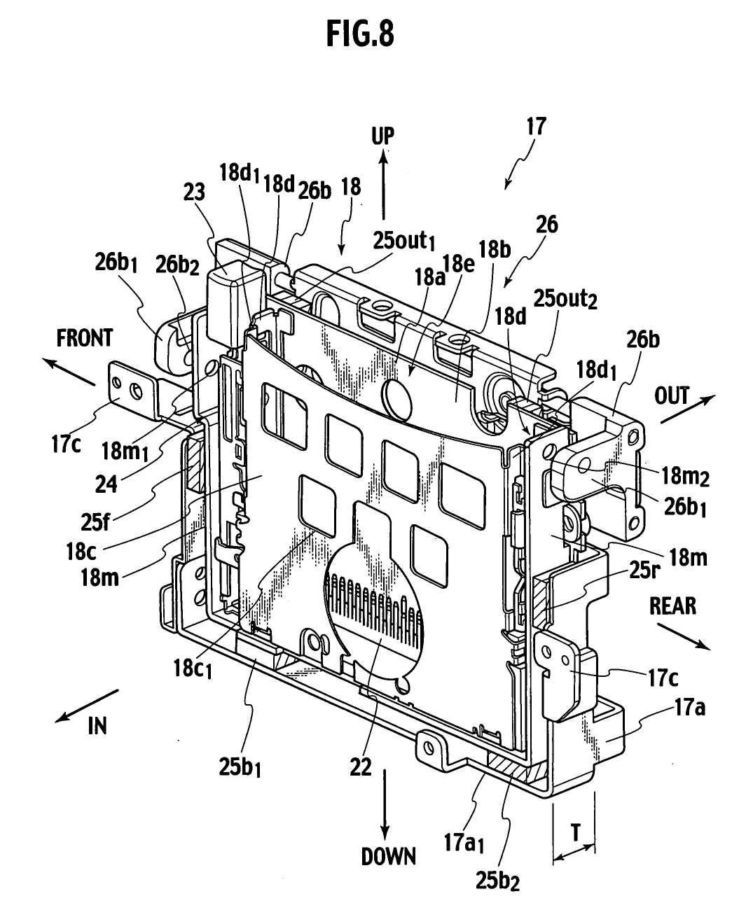

Next, the medium housing unit 17 housing the cartridge 20 will be described mainly with reference to FIGS. 8, 9, and 10.

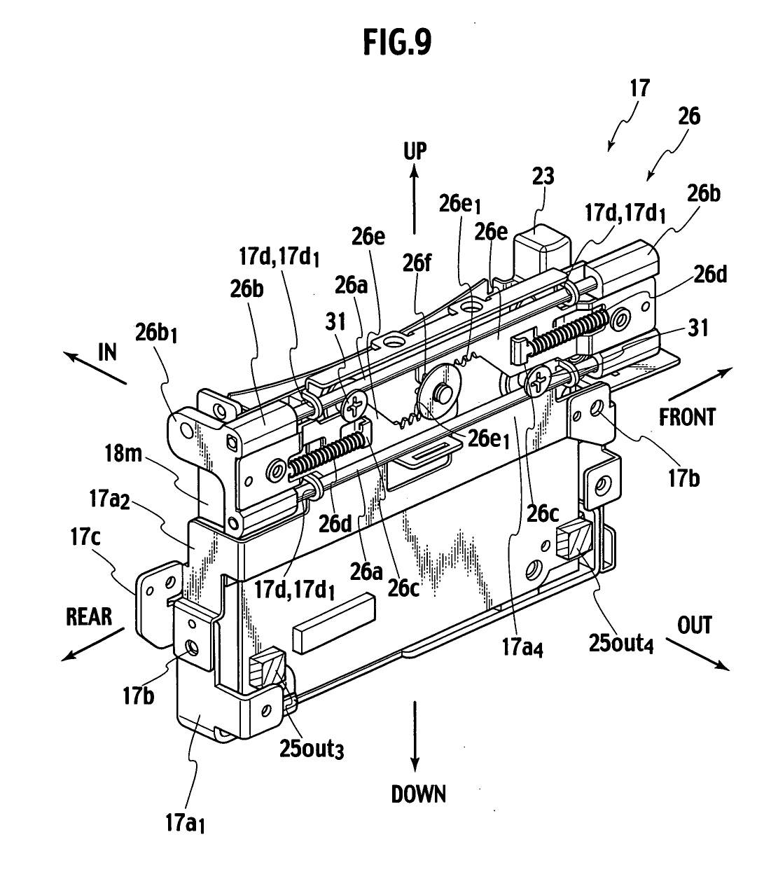

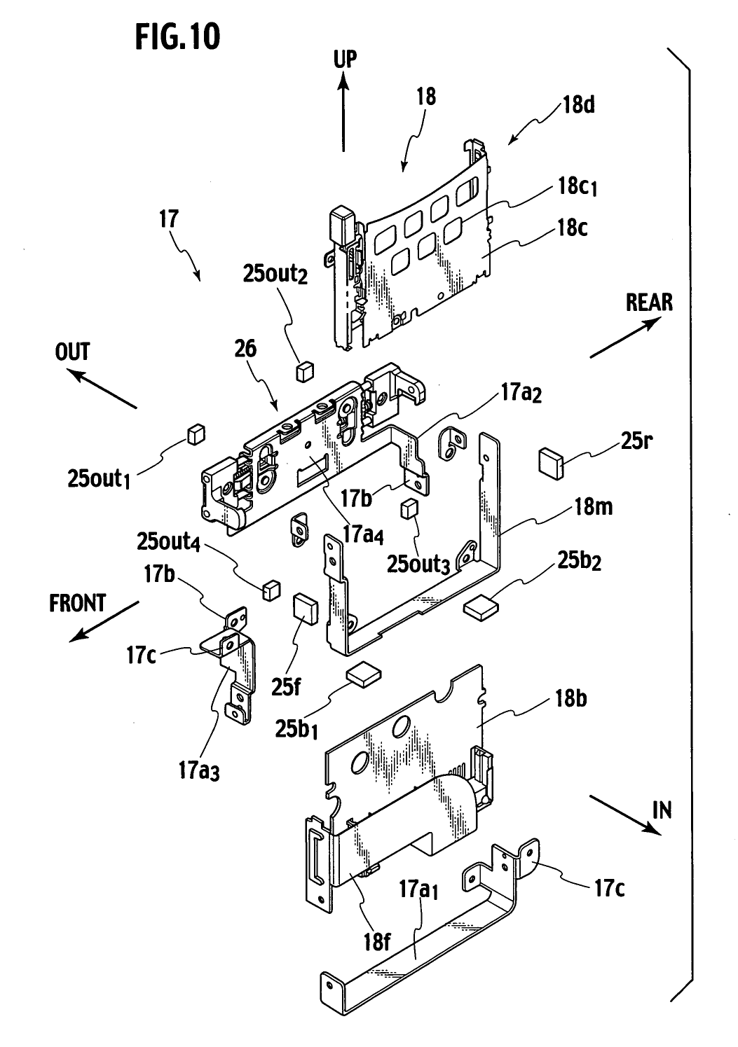

FIG. 8 is a perspective view in which the medium housing unit 17 is seen obliquely from the upper rear direction of the inside of the appliance 500 in which the medium housing unit 17 is disposed. FIG. 9 is a perspective view of the unit 17 seen obliquely from the upper rear direction of the outside of appliance 500. FIG. 10 is an exploded perspective view.

In each figure, a FRONT, a REAR, an UP, a DOWN, an INSIDE, and an OUTSIDE direction are shown when the medium housing unit 17 is mounted in the video camera 500 for the sake of easy understanding. These notations will be used for a description of direction in the following as the case may be.

The recording medium housing 17 has a base frame 17a that has been produced into substantially a frame shape having substantially a width of T by pressing and forming a thin metal sheet as a starting material. The recording medium housing 17 is composed by joining a first frame 17a1, a second frame 17a2, and a third frame 17a3.

The first frame 17a1 is formed into substantially a U-shape, being disposed on a lower face of the recording medium housing 17.

The second frame 17a2 has a wide portion 17a4 supporting a slot lock mechanism 26 (described in detail later). The second frame 17a2 is fastened to the first frame 17a1 by a screw (not shown) passing through two fastening portions 17b, 17b so as to have the third frame 17a3 interposed therebetween.

The base frame 17a has two lobe portions 17c, 17c extending along the FRONT/REAR direction. The lobe portions 17c, 17c and the body unit 500B of the video camera 500 are combined with each other to be integrated by a screw.

The second slot portion 18 (referred to as a slot portion 18 hereinafter) has a substantially U-shaped main frame 18m having an open upper end and a main plate 18b composed of a printed circuit board fastened to the main frame 18m. The main frame 18m is formed of metal.

The main plate 18b, a back plate 18c that opposes the main plate 18b and is formed of a thin metal sheet having a plurality of weight reducing holes 18c1 for making the back plate 18c lightweighted, and a pair of side plates 18d, 18d disposed between the main plate 18b and the back plate 18c constitutes a housing portion 18e having a shape of substantially a flattened rectangular envelope.

The side plate 18d is comprised of a guide portion 18d1 that fits with the step portion 20a of the cartridge 20 and the guide portion 18d1 serves to guide the step portion 20a when the cartridge 20 is inserted or removed.

A deeper portion (lower portion) of the housing portion 18e is provided with a male connector 22 fixated on the main plate 18b. The connector 22 is electrically connected with a wiring pattern provided on the main plate 18 and then with the signal control substrate 15 (see FIG. 6) of the video camera 500 via a flexible substrate 18f (see FIG. 10).

In FIG. 8, a part of the back plate 18c is circularly removed only for the purpose of easy understanding of the configuration of the male connector 22 therein.

When the cartridge 20 is inserted into the opening 18a of the slot portion 18 configured above, the cartridge 20 is guided along the insertion direction with the step portion 20a thereof fitted with the guide portion 18d1 and thus comes to be housed in the slot portion 18.

When the cartridge 20 is pressed further down, the female connector 20b is engaged and electrically connected with the male connector 22. As a result, the cartridge 20 becomes recognizable as a recording medium of the video camera 500 as an information processing appliance.

A side plate 18d in a rear end of the slot portion 18 is provided with a release mechanism 24 (not shown in detail) to be used for removing the cartridge 20 from the male connector 22.

The release mechanism 24 is configured in such a way that, when the cartridge 20 is housed in the recording medium housing 17, a downward movement of a release lever 23 allows an arm (not shown) connected to the release lever 23 by a linkage mechanism to raise the cartridge 20 up until the female connector 20b is physically disconnected from the male connector 22. The cartridge 20 removed from the connector 22 can be taken away from the recording medium housing 17 by picking up the cartridge 20.

The mechanism 24 is able to work as above every time the cartridge 20 is removed therefrom, since the release mechanism 24 is re-set every time the cartridge 20 is inserted into the recording medium housing 17.

A structure for supporting the slot portion 18 in the recording medium housing 17 will be described in detail.

As mentioned above, the video camera 500 according to the second embodiment is configured to prevent an excessive shock from being applied to the slot portion 18 by absorbing the shock from a direction perpendicular substantially to the side face of the cartridge 20. Furthermore, other measures are taken in order to reduce the shock from other directions.

Namely, in order to prevent an excessive acceleration from being applied to the cartridge 20 by absorbing the shock from outside, the slot portion 18 for housing the cartridge 20 is configured to be supported with respect to the body unit 500B and the recording medium housing 17 integrated with the body unit 500B by use of a buffer member 25.

This configuration will be described specifically with reference to FIGS. 8 to 12.

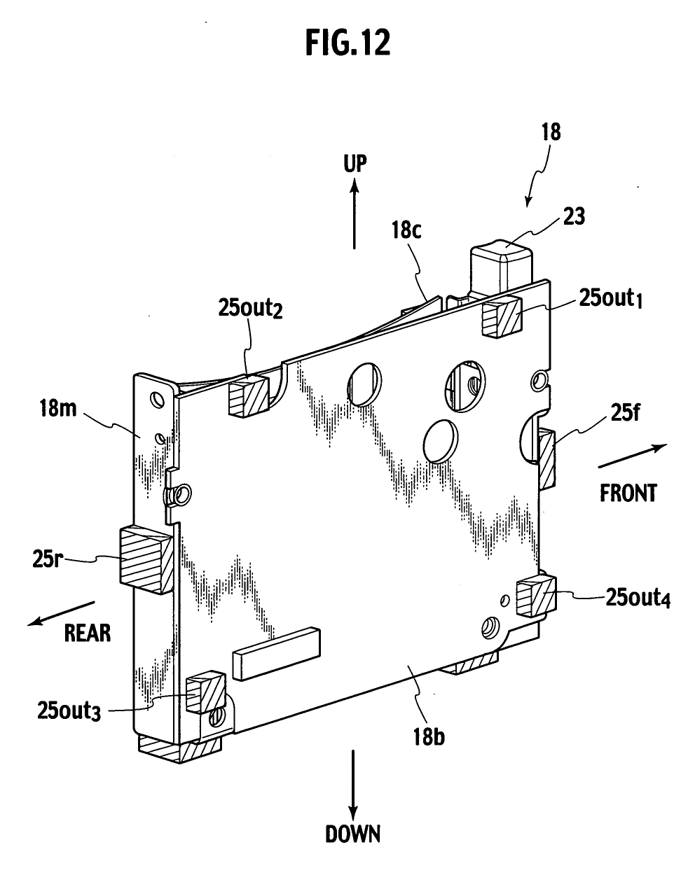

FIGS. 11 and 12 illustrate only the slot portion 18 in contrast with FIGS. 8 and 9.

First of all, regarding the IN direction, four buffer members 25in1, 25in2, 25in3, and 25in4 each are attached on the vicinity of each of the four corners of the back plate 18c as shown in FIG. 11 so as to lie between the back plate 18c and the body unit 500B.

Regarding the FRONT direction, a buffer member 25f lies between the main frame 18m and the base frame 17a, as shown in FIG.8. The buffer member 25f is attached on both frames 18m, 17a.

Regarding the REAR direction, a buffer member 25r lies between the main frame 18m and the base frame 17a. The buffer member 25r is attached on both frames 18m, 17a.

Regarding the OUT direction, four buffer members 25out1, 25out2, 25out3, and 25out4 each are attached in the vicinity of each of four corners of the main plate 18b.

Among these four buffer members, the upper two buffer members 25out1 and 25out2 are attached on a lock mechanism supporting portion 17a4 and the main plate 18b, respectively, so as to stay therebetween.

On the other hand, the lower two buffer members 25out3, 25out4 are attached on the main plate 18b and the body unit 500B, respectively, so as to stay therebetween.

Regarding the DOWN direction, two buffer members 25b1 and 15b2 are attached on the main frame 18m and the base plate 17a, respectively, so as to stay therebetween.

Regarding the UP direction, two buffer members 25t1 and 25t2 are attached on an inner face of the hinge flip cover 7 (see FIG.5). These two buffer members 25t1 and 25t2 abut the upper face of the cartridge 20 when the cover 7 is closed. It should be noted that each buffer member having a different suffix may be referred to collectively as a buffer member 25 hereinafter.

By the way, the buffer member 25 is attached preferably using a double-sided adhesive tape. However, an adhesive agent, or the like can be used.

With the above configuration, the slot portion 18 housing the cartridge 20 is supported in relation to the body unit 500B of the video camera 500 only by buffer members 25.

In other words, since each buffer member 25 can deform in accordance with force exerted from outside so as to absorb the force, the slot portion 18 is practically floated or loosely supported so as to move to some extent in every direction in relation to the video camera 500.

Namely, when the slot portion 18 is supported in such a way, a permissible amount in a relative position of the slot portion (housing portion) 18 for housing the cartridge 20 with respect to a body portion (the body unit 500B) of the video camera 500 is set to be larger compared with where the slot portion 18 is rigidly supported.

As the buffer member 25 is used a commercially available buffering material such as but not limited to rubber, elastmer, gel, which are all used for the purposes of shock absorbing. In order to downsize the appliance 500, each buffer member 25 needs to be thinner as far as a predetermined anti-shock performance is obtained. Under this circumstance, a so-called gel material having an excellent buffering performance is preferably used.

In the video camera 500 according to the second embodiment, each buffer member 25 should preferably be 5 millimeters (mm) thick or less in order to downsize the camera 500 as much as possible, while ensuring a predetermined shock-absorbing performance. In other words, an impact shock caused on the cartridge 20 by a fall of 70 centimeters (cm) has to be 200 gravitational acceleration (G) or less.

In this embodiment, a low hardness gel material having a thickness of 2 to 3 mm and a contact area of 25 meters square (mm²) is used as the buffer member 25.

It is confirmed that this buffer member 25 satisfies the above shock-absorbing performance.

By the way, each face of the cartridge 20 has a different permissible value of impact shock. For example, a permissible value of impact shock exerted on the larger face of the cartridge has to be smaller than on the smaller face that constitutes a side face of the cartridge 20.

Therefore, the buffer member 25 that is to absorb an impact shock exerted on the larger face has to have a higher shock-absorbing performance.

For example, the shock-absorbing performance can be optimized by changing a thickness and a contact area of the buffer material, a position in which the buffer member is disposed, the number of the buffer members, and physical properties (elasticity modulus and hardness).

By the way, the buffer member is shaped of a rectangular parallelepiped, one face of which is attached on the slot portion 18 and the opposing face of which is attached on the body unit 500B. Therefore, the buffer member can absorb an impact shock exerted thereon in a direction perpendicular to the face thereof by its own contraction or expansion and in a direction parallel to the face thereof by its shear resistance.

In other words, the slot portion 18 is practically floated or loosely supported using both buffering action demonstrated by the contraction/expansion and by the shear resistance of the buffer member in this embodiment.

The buffer members 25f, 25r, 25b1, and 25b2 attached on a front face, a rear face, a front bottom portion, and a rear bottom portion, respectively, can exhibit buffer action by a shear resistance against the impact shock in the IN/OUT direction so that the four buffer members 25out1 to 25out4 attached on the main plate 18b and the other four buffer members 25in1 to 25in4 attached on the back plate 18c can be thinner. Therefore, the video camera 500 according to the second embodiment is downsized in width (in a right to left direction).

On the other hand, in the second embodiment, the buffer members 25out1 to 25out4 attached on the main plate 18a and the buffer members 25in1 to 25in4 attached on the back plate 18c have a low hardness of 6 in a unit of JIS A and are made of a material excellent in vibration absorbing performance.

The buffer members 25f, 25r, 25b1, 25b2, 25t1, and 25t2 are made of a low hardness buffering material having a hardness of 80 in a unit of ASKER FP, which corresponds to about 8 in a unit of JIS A.

As described above, since the buffer members for absorbing an impact shock exerted along the IN/OUT direction has better vibration suppression than those for absorbing an impact shock exerted along the UP/DOWN or the FRONT/REAR direction, an impact shock applied to the main plate 18b and the back plate 18c having a lower permissible value is effectively absorbed.

By the way, it is known that low molecular weight siloxane vaporized from silicone rubber or adhesive agent can cause troubles in electrical contacts of switches or the like.

The buffering material may contain silicone and its compounds in order to have a suitable property as a buffering material.

Since the cartridge such as a microdrive mentioned above is not completely sealed, low molecular weight siloxane may have an adverse effect on the built-in HDD. In addition, since an information processing appliance has many switches for its operation, troubles in electrical contacts may occur by the chemical.

Therefore, the buffer member used is preferably made of non-silicone material that has no such a disadvantage.

As stated above, the cartridge 20 has the female connectors 20b for electrical connection on one face thereof and is mounted on and off the slot portion 18 by inserting the female connectors 20b in and out the male connectors 22 provided in the slot portion 18.

Therefore, the male connector 22 of the appliance 500 needs to be firmly supported so as to assure the electrical connection when the cartridge 22 is mounted and at the same time the connector 22 needs to be supported so as to allow prompt removal of the cartridge 20 when the cartridge 20 is removed.

Since the slot portion 18 is supported in a floating manner, it is not very easy to insert the cartridge 20 only by guiding the step portion 20a along the guide portion 18d1 when the cartridge 20 is inserted into the slot portion 18. Therefore, the cartridge 20 may not be inserted quickly.

In addition, there may arise a disadvantage in that the cartridge 20 is not removed easily, because the connector is not rigidly supported or because the cartridge 20 is shaky at the time of removal of the cartridge 20.

Furthermore, if the cartridge 20 is forced to be inserted into the slot portion 18, the connector 20b may be damaged, thereby deteriorating reliability.

The video camera 500 according to the second embodiment has a configuration that can eliminate the above-mentioned possible disadvantages.

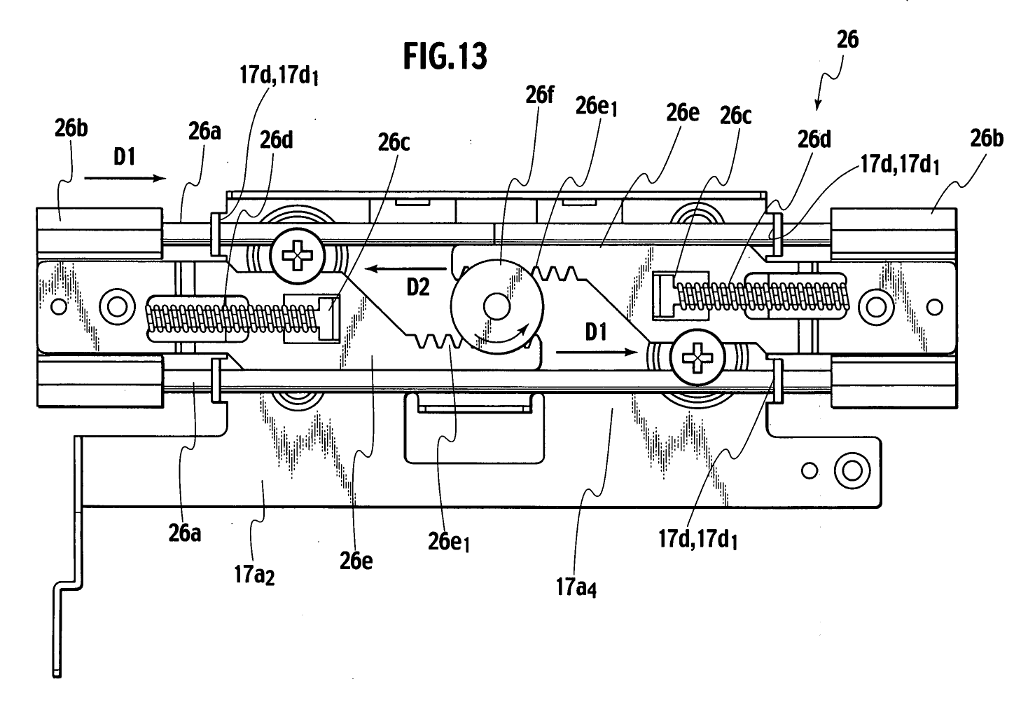

Referring to FIGS. 9 and 13, there will be described a slot lock mechanism 26 that makes it possible to insert the cartridge 20 in and out assuredly and easily.

The slot lock mechanism 26 is provided on the lock mechanism support portion 17a4 that is the wide portion of the second frame 17a2 of the recording medium housing 17, as shown in FIG. 9.

The slot lock mechanism 26 is configured to have a pair of parallel shafts 26a, 26a each penetrating two shaft support holes 17d1, 17d1 each made in two protrusions 17d, 17d extending from the second frame 17a2, a pair of substantially an L-shaped lock plates 26b, 26b that receive an end portion of the shafts 26a, 26a and allows the shafts 26a, 26a to slide along the longitudinal direction thereof, a pair of spring support portions 26c, 26c that are formed by severing a part of the second frame 17a2 and raising the part, a pair of spring coils 26d, 26d, one end of which is connected to the spring support portion 26c and the other end of which is connected to the lock plate 26b, the spring coils biasing the lock plate 26b on both ends of the shaft 26a, a pair of rack boards 26e, 26e that are secured on one lock plate 26b and extends toward the other lock plate 26b, the pair of rack boards 26e, 26e having rack portions 26e1, 26e1 opposing laterally each other, and a gear 26f that is engaged with the pair of the rack portions 26e1, 26e1 and transmits a movement of one rack board 26e along the shaft 26a to cause the other rack board 26e to move in the opposite direction.

Therefore, one lock plate 26b and the other lock plate 26b move in the opposite direction with respect to each other.

In the slot lock mechanism 26, the shaft 26 is threadably secured on a lock mechanism support portion (wide portion) 17a4 using a flat-headed screw 31.

The lock plate 26b is made of metal such as but not limited to Aluminium.

The lock plate 26b is biased outward by a biasing force exerted thereon by the spring coil 26d. However, the lock plate 26b comes to halt in a predetermined position as shown in FIG. 13 by a positioning means (not shown). This situation shown in FIG. 13 is referred to as a first support state hereinafter.

Under the first support state, when the force that opposes the biasing force exerted from the spring coil 26d is applied on the left lock plate 26b in FIG. 13, for example, this lock plate 26b moves accordingly along the shaft 26a in the D1 direction.

With this movement, the rack board 26e secured on the lock plate 26b also moves in the D1 direction in FIG. 13, thereby rotating in a counter-clock direction the gear 26f with which the rack portion 26e1 is engaged.

Then, the other (right) rack board 26e with which the gear 26f is engaged moves in the D2 direction, thereby shifting the other lock plate 26b on which this rack board 26e is secured in the D2 direction.

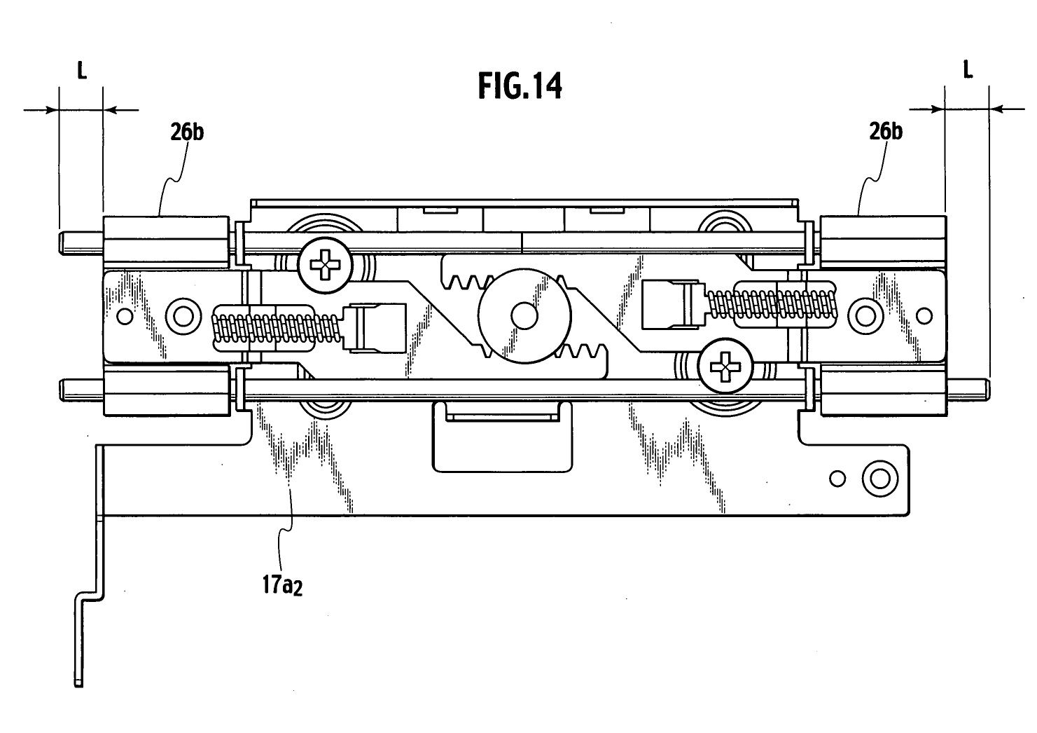

Due to this movement, both lock plates 26b, 26b come closer by a given distance of L as shown in FIG. 14. This situation as shown in FIG. 11 is referred to as a second support state hereinafter.

The lock plate 26b has an arm portion 26b1 extending in an L-shape from its body portion and is engaged with the shaft 26a as shown in FIGS. 8 and 9. On an inner face of the arm portion 26b1, a protrusion 26b2 is formed so as to extend in substantially a cone shape.

The protrusion 26b2 is configured so as to be engaged with lock holes 18m1, 18m2 provided on the main frame 18m.

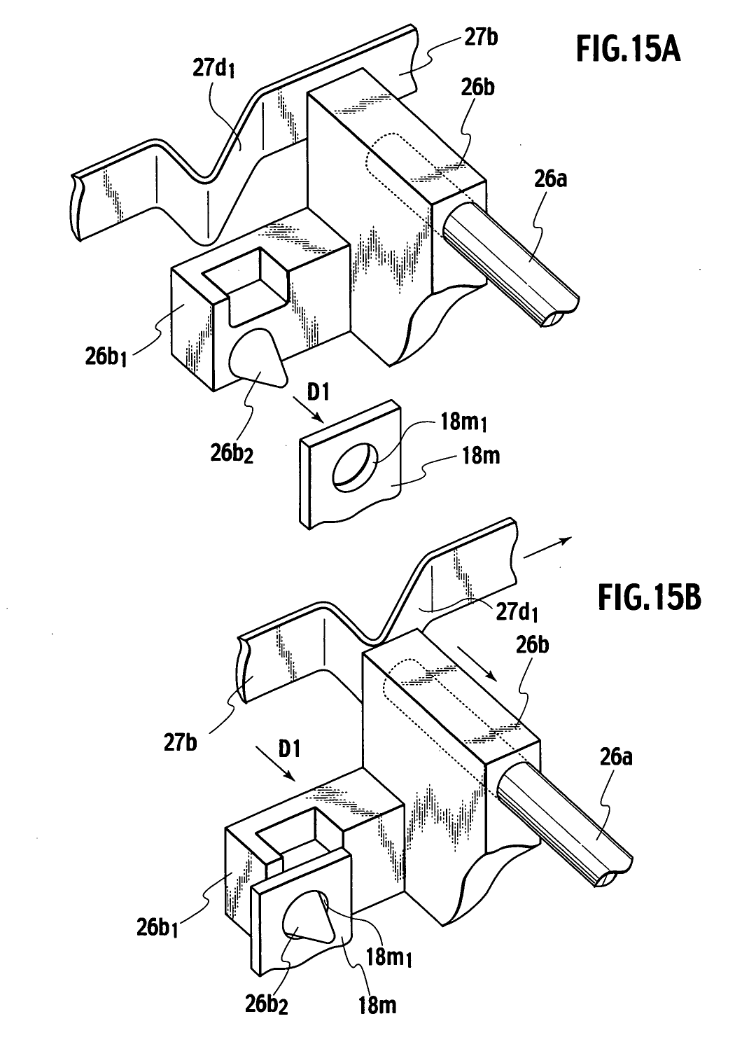

How the protrusion 26b2 is engaged with the lock holes 18m1, 18m2 will be described referring to FIGS. 15A and 15B.

FIGS. 15A and 15B are an enlarged perspective view of the vicinity of the arm portion 16b1 of the lock plate 26b and the lock hole 18m1 of the main frame 18m. The arm portion 16b1 and the lock hole 18m1 in FIGS. 15A and 15B are those positioned near the front end of the recording medium housing 17 illustrated in FIG. 8. FIG. 15A illustrates the first support state. FIG. 15B illustrates the second support state.

As shown in FIG. 15A, the protrusion 26b2 is positioned away from the main frame 18m in the first support state. Therefore, the slot portion 18 is supported in a floating manner only by each buffer member 25.

On the other hand, in the second support state as shown in FIG. 15B, the lock plate 26b shifts along the shaft 26a in the D1 direction and thereby the protrusion 26b2 comes to an engagement with the lock hole 18m1 of the main frame 18m.

Therefore, the main frame 18m is restricted against the lock plate 26b and supported substantially integrally and rigidly. In other words, the slot portion 18 and the body unit 500B come to be substantially integrated.

Therefore, when the cartridge 20 stays mounted in the video camera 500, the cartridge 20 is supported in a floating manner since the lock plate 26b takes the first support state. However, when the cartridge 20 is inserted or removed, the cartridge 20 is supported rigidly, because the lock plate 26b takes the second support state and thus the male connector 22 is not excessively shaky. As a result, the cartridge 20 can be inserted assuredly and smoothly, thereby preventing damage and connection failure in the connectors.

In addition, since the cartridge 20 does not excessively shake at the time of removal, the cartridge 20 can be easily pinched by fingers and thus removed easily and smoothly.

Whilst the second support state does not necessarily require that the slot portion 18 stay completely stationary with respect to the body unit 500B without leaving any allowance, the slot portion 18 is supported substantially rigidly in the second support state.

In other words, the cartridge 20 can move only slightly so that the connector 20b is inserted easily and securely. It is only required that when the cartridge 20 is inserted into the slot portion 18 the second support state enables the cartridge 20 to be restricted allowing for less shaky movement of the cartridge 20 compared with the first support state.

In summary, a permissible amount of shift in a relative position of the slot portion 18 for housing the cartridge 20 in relation to the body unit 500B of the video camera 500 is much smaller in the second support state than in the first support state.

The permissible amount of shift in the second support state is determined by the size of the protrusion 26b2 and the lock hole 18m1. Namely, the permissible amount corresponds to a clearance between a diameter of the protrusion 26b2 and an inner diameter of the lock hole 18m1 when the lock plate 26b stays in the second support state in which the protrusion 26b2 penetrates the lock hole 18m1 as shown in FIG. 15B.

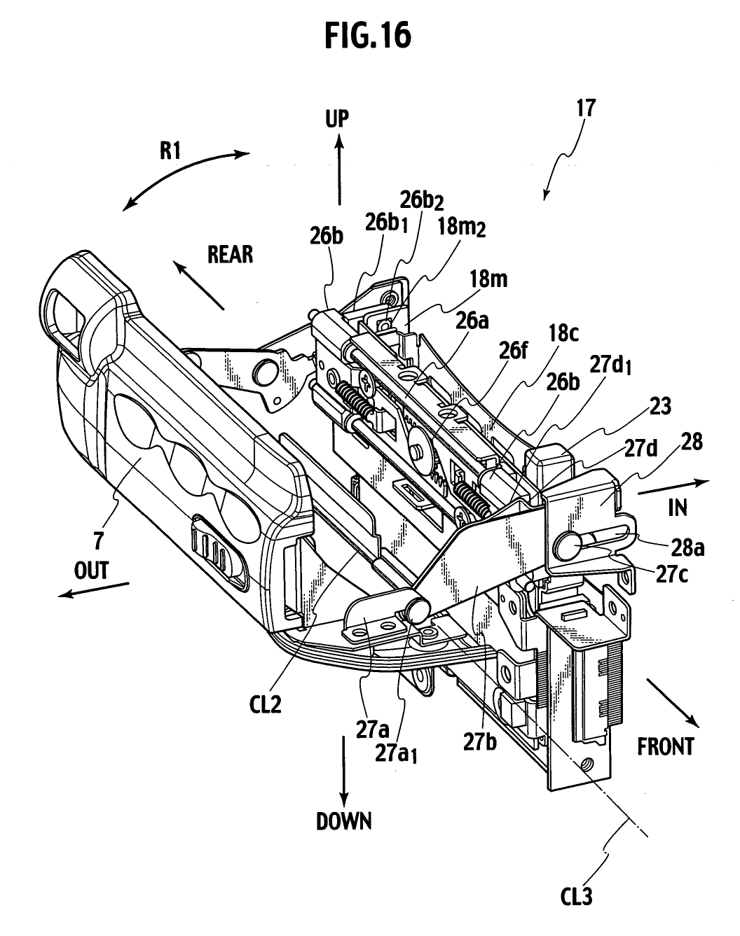

Next, how the first support state is switched to the second support state and conversely will be described referring to FIG. 16.

As described above, the second support state is realized at the time of inserting the cartridge 20. Switching between the two states are carried out by an open/close movement of the hinge flip cover 7 in the second embodiment.

FIG. 16 illustrates the vicinity of the hinge flip cover 7 and the recording medium housing 17 shown is FIG.5.

In this video camera 100, the cartridge 20 is inserted or removed after the hinge flip cover 7 is opened. The first support state is realized when the hinge flip cover 7 is closed, whilst the second support state is realized when the hinge flip cover 7 is opened.

Specifically, in an inner front portion of the hinge flip cover 7 is attached a hinge base portion 27a to which a hinge arm 27b is connected. The hinge arm 27b is pivotable around a fastening portion (pivot) 27a1.

There is provided a slide pin 27c at the front portion of the hinge arm 27b.

In a hinge guide 28 provided on the body unit 500B, there is provided a guide hole 28a having a shape of slit extending along the IN/OUT direction. With the guide hole 28a receives the slide pin 27c of the hinge arm 27b.

With this configuration, when the hinge flip cover 7 is pivoted around the pivot axis CL2 and closed, the slide pin 27c is guided along the guide hole 28a and thus the hinge arm 27b moves substantially horizontally in the IN direction.

On the other hand, there is formed a slope portion 27d near the lock plate 26b and on the hinge arm 27b. The slope portion 27d is sloped so that a distance between a slope face 27d1 thereof and the hinge arm 27b increases gradually toward the IN direction.

When the hinge flip cover 7 is opened, the slope face 27d1 of the slope portion 27d abuts and moves the lock plate 26b in the REAR direction. As a result, the lock plate 26 comes to be in the second support state (see FIG. 15B).

A closing of the hinge flip cover 7 allows the hinge arm 27 to move the slope portion 27d in the IN direction. Thus, the lock plate 26b slides in relation to the shaft 26a toward the FRONT direction by a biasing force exerted from the spring coil 26d. As a result, the lock plate 26b comes to stay away from the main frame 18m. In other words, the lock plate 26b comes to be in the first support state (see FIG. 15A).

In the second embodiment, the first support state and the second support state are switched reciprocally depending on the opening/closing of the hinge flip cover 7.

By the way, the switching is not limited to the embodiment described above but can be altered.

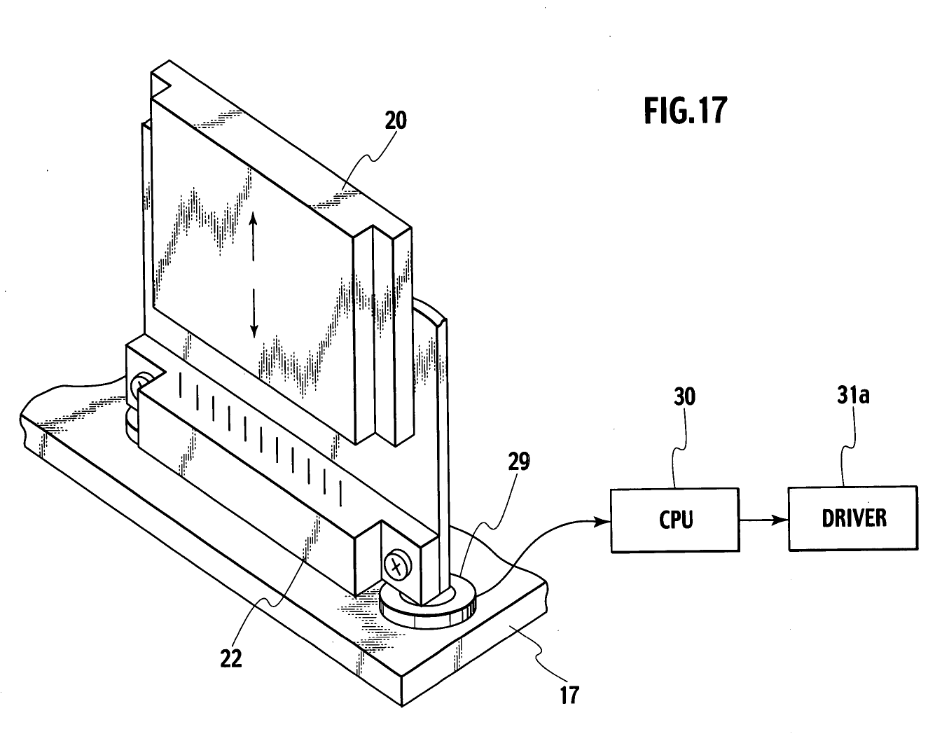

For example, the following configuration is possible as a first modification. Namely, while there is provided on the base frame a pressure sensor 29 that detects a pressure exerted on the male connector 22 along the insertion/removal direction as shown in FIG. 17, the body unit 500B is provided with a central processing unit (CPU) 30 that determines whether the first support state or the second support state is realized based upon the signal from the pressure sensor 29 and thus outputs an instruction signal, and a driver 31a that shifts the lock plate 26b into the determined support state based upon the signal outputted from the CPU 30.

In this first modification, when the pressure sensor 29 detects a pressure of a predetermined value or higher, the sensor 29 determines that the cartridge 20 is being inserted or removed and thus the CPU 30 controls to shift the lock plate 26b into the second support state. When the pressure sensor 29 stops detecting the pressure, the CPU 30 realizes the first support state.

This modification is preferable when the hinge flip cover that covers the opening of the slot portion is not provided in an information processing appliance. Nothing to say that the CPU 15a mounted on the substrate 15 can be used instead of the CPU 30.

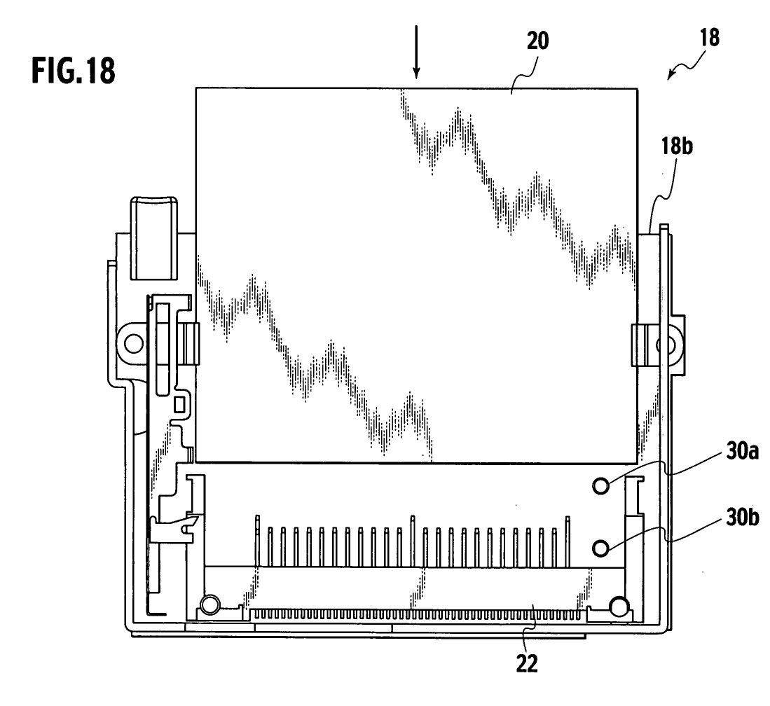

Next, a second modification will be described referring to FIGS. 18 to 20. This second modification has the CPU 30 (15a) and the driver 31a (not shown) as is the case with the first modification.

FIGS. 18 to 20 are a schematic side view of the slot portion 18, each illustrating a different position of the cartridge 20 along the direction shown by an arrow in the figures. In addition, the first support state is a norm in this modification.

FIG. 18 illustrates where the cartridge 20 is inserted halfway into the male connector 22.

In the second modification, there are provided a first position sensor 30a and a second position sensor 30b that are arranged on the main plate 18b as a substrate, leaving a predetermined distance therebetween. The sensors 30a, 30b transmit an output signal to the CPU 30 (15a).

In the configuration shown in FIG. 18, since the cartridge 20 stays away from the two position sensors 30a, 30b, no detection signal is transmitted.

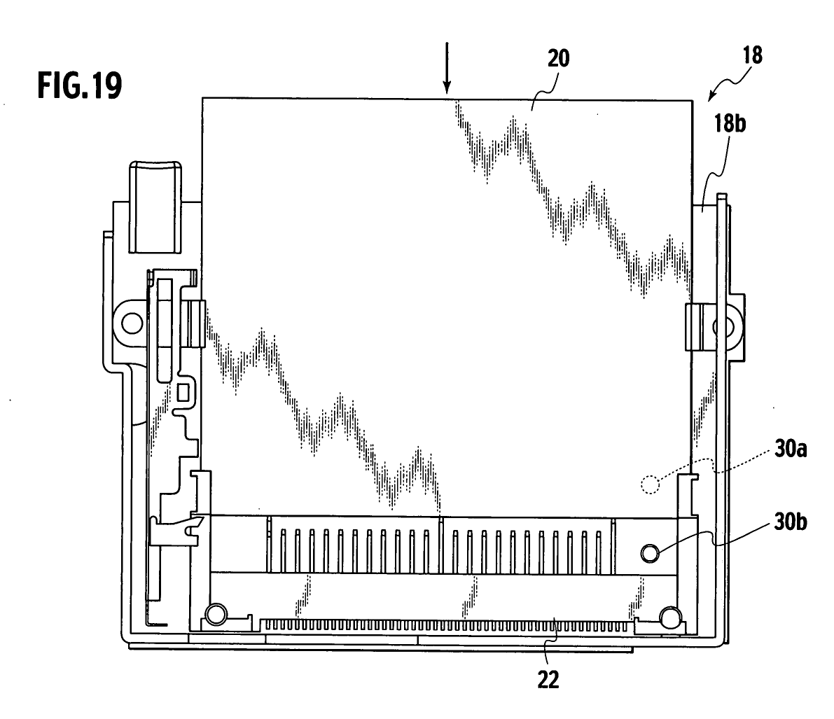

FIG. 19 illustrates where the cartridge 20 is pressed further down in contrast with that shown in FIG. 18.

In this situation shown in FIG. 19, the cartridge 20 stays close enough to trigger the first position sensor 30a to output a detection signal.

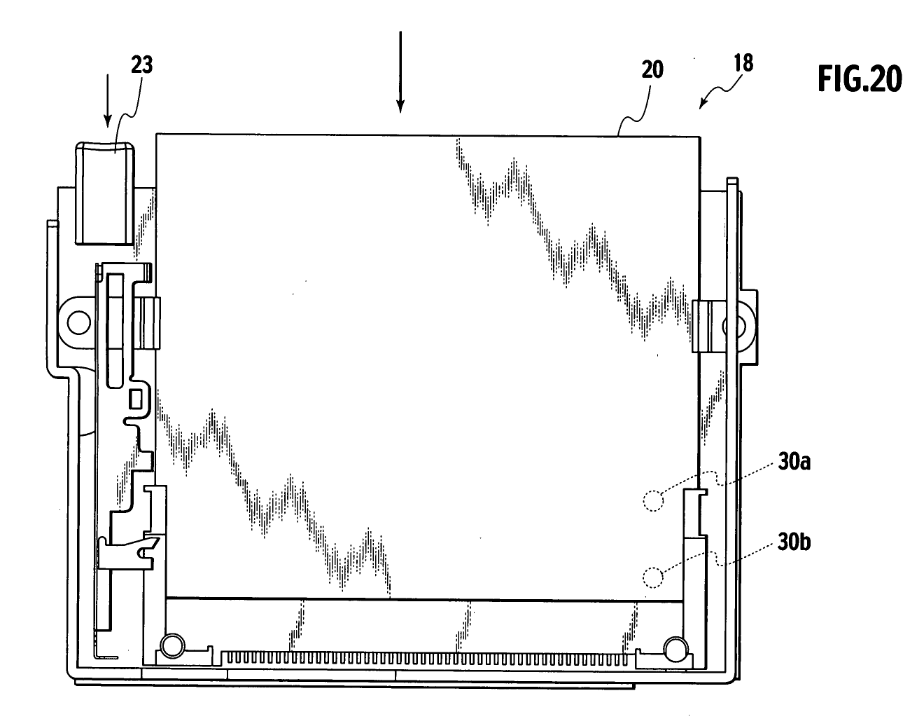

FIG. 20 illustrates where the cartridge 20 is pressed yet further down compared with that shown in FIG. 19 and the female connector 20b of the cartridge 20 is fully inserted into the male connector 22.

When the cartridge 20 is being moved from the position shown in FIG. 19 to that in FIG. 20, the cartridge 20 comes close to the second position sensor 30b and thus the sensor 30b as well as the sensor 30a detects the cartridge 20 to output a detection signal.

Therefore, since the first position sensor 30a outputs the detection signal first and next the second position sensor 30b outputs the detection signal, the CPU 30 (15a) as a control means can determine that the cartridge 20 is being inserted and allow the driver 31a to control the lock plate 26b into the second support state.

When the cartridge 20 is removed, the release lever 23 is pressed down in a direction shown by the arrow and thus the cartridge 20 is raised until the female connector of the cartridge 20 is removed from its mating connector provided in the slot portion 18. At this time, the cartridge 20 comes to assume a position again as shown in FIG. 19.

In this modification, there is provided a sensor (not shown) that detects depression movement of the release lever 23. When the sensor detects the movement, the CPU 30 determines that the cartridge 20 is being removed and allows the driver 31a to control the lock plate 26b accordingly.

After the cartridge 20 was mounted into the slot portion 18 of the video camera 500 (weighted of 320 grams with batteries included) according to the above-stated embodiment and the hinge flip cover 7 was closed, a drop test of 70 cm was carried out in order to measure an impact shock (acceleration G) exerted on the cartridge. The test was carried out six times, in each of which each one of six sides of the video camera hit the floor.

Since the cartridge 20 was mounted and the hinge flip cover 7 was closed, this drop test was carried out for the video camera 500 in which the first support state is realized. Specifically, the impact shock was measured with a small acceleration switch having a diameter of 2 mm attached on three different faces of the cartridge 20, the three different faces being orthogonal to one another.

The buffer members attached on the faces perpendicular to the FRONT/REAR direction have a thickness of 2 mm and their total area is about 30 mm². The buffer members attached on the faces perpendicular to the UP/DOWN direction have a thickness of 2 mm and their total area of about 60 mm².

On the other hand, the buffer members attached on the faces perpendicular to the IN/OUT direction have a thickness of 3 mm and their total area is about 30 mm².

By the way, for a comparison purpose, a video camera was manufactured in which a slot portion and a recording medium housing, both of which correspond to the slot portion 18 and the recording medium housing 17 in the embodiment according to the present invention, were combined firmly with each other by an epoxy adhesive. Then, the same drop test was carried out to measure an impact shock using this video camera for the comparison.

From the measurement results in the drop test, it has been found that the impact shock exerted on the cartridge 20 in the video camera for a comparison exceeds a permissible value of 200 G that is required for the cartridge 20 in operation, thereby possibly causing a damage on the cartridge 20, whilst the cartridge 20 in the video camera 500 experiences only an impact shock lower than 200 G in every one of the six tests, thereby being free of damage.

Referring to the above embodiment, the present invention has been disclosed. However, the present invention is not limited to the embodiment above and can be altered or modified without departing from the scope of the invention.

The above embodiment and modifications have described the portable image display appliance and the video camera into which the present invention is embodied. However, the present invention is embodied into any information processing appliance such as but not limited to a digital still/video camera, a note-type personal computer, a document presenter, a portable music player, a personal digital assistance, a game console, a video player, and a disc recorder utilizing a Digital Versatile Device, a Blu-Ray disc or the like. In other words, the information processing appliance here means an apparatus that records or reads data on or from a recording medium.

In addition, the information processing appliance into which the present invention is embodied includes not only a carriageable appliance described in the embodiments but also a so-called desktop type apparatus.

Moreover, whilst a hard disc is utilized as a recording medium built-in in a cartridge in the second embodiment, the medium is not limited to a hard disc but may be an optical disc or the like. In other words, the cartridge may house a driver that drives such discs.

Each embodiment described above is not intended to limit the present invention to the above configurations and procedures. The present invention can be, nothing to say, modified without departing from the scope and the sprit thereof.

What is claimed is:

1. An information processing appliance comprising:
a casing,
a wall portion formed integrally with said casing so as to arise inward from said casing, and
a slot portion housed inside said casing and supported by said wall portion, said slot portion housing removably a cartridge carrying a disc-like recording medium.

2. An information processing appliance comprising:
a first casing,
a second casing,
a slot portion housed inside said first casing, the slot portion housing removably a cartridge carrying a disc-like recording medium, and
a camera unit portion outputting image data of a captured image,
wherein said second casing is mounted on said first casing so that one face of said first casing and one face of said second casing closely oppose each other, and wherein said slot portion is housed so as to be on and along said one face of said first casing.

3. An information processing appliance as recited in claim 2, said second casing is pivotably configured in relation to said first casing.
